(19) United States
(12) Patent Application Publication
(10) Pub. No.: US 2015/0170195 A1
(43) Pub. Date: Jun. 18, 2015

(54) System and Method to Collect, Correlate and Display Customer Origination Data with Customer Revenue Data

(71) Applicant: Aaron Drew, Washington, DC (US)

(72) Inventor: Aaron Drew, Washington, DC (US)

(21) Appl. No.: 14/106,599

(22) Filed: Dec. 13, 2013

(51) Int. Cl. G06Q 30/02

(52) U.S. Cl. CPC G06Q 30/0242

(57) ABSTRACT

A customer or patient management system implemented on a computer or computer network is disclosed that includes at least one electronic device having a display; a memory; and a processor operating in accordance with software for receiving a unique identifier associated with a customer and the identifier is associated with a predefined marketing campaign. The system captures and stores data that allows for the calculation of payment history for each customer and the cost data relating to the advertising and promotion expenditures for each customer that originates from each predefined marketing campaign and correlating the revenue and expenditure data for each customer in a visual display.

The applicant claims the benefit of the filing date of U.S. Application No. 61,736,727 filed Dec. 13, 2012.

The present invention relates to a system and methods generally for determining and tracking the relative value of services provided by service providers over the lifetime of a service relationship. The invention has particular use in the medical, dental, legal, and automotive service industries. More particularly, the present invention relates to coordinating and tracking the manner in which a new patient or customer is first associated with the service provider and then tracks the lifetime of revenue for services provided to the customer or patient.

The invention may be used as an integral part of an overall process of investing in the marketing and promotion of services followed by providing services to customers or patients and takes advantage of information technologies, wireless systems, local area networks, wide area networks, and the Internet to track the relative value and effectiveness of the marketing efforts thereby allowing the service provided to better target advertising and promotional efforts to most cost efficient techniques. The system and methods disclosed thereby can reduce operating costs and maximize efficiency. The invention also relates to methods and apparatus for streamlining business practices to more efficiently serve customers and improve profitability.

Existing systems also can track a patient or customers prior visits, allergies and other risk management alerts, such as drug-to-drug conflicts.

Another medical management system for medical services providers is that distributed by QuadraMED of San Rafael, Calif. QuadraMED provides a system with a focus on clinical and financial data by providing a database of patient management information such as insurer, age, gender, contact information, visit schedules and chart location. The QuadraMED system also manages financial and clinical information and attempts to increase practice profitability by checking for and reducing redundant data entry and generating summary and detailed management reports on practice efficiency.

Yet another medical management computer system sold to medical service providers is that distributed by Healtheon/WebMD of Atlanta, Ga. This system also integrates numerous sub-systems which include sub-systems to confirm and process referrals and authorization, submit and track insurance claims for collecting, order and check laboratory tests, distribute text-based and administration information across email, fax, mail, and retrieve patient information from a common patient database.

Many of the existing medical management systems that are commercially availablefocus on accepting patient demographics, scheduling patient visits, and creating charges and submitting them to the party responsible for payment. These prior art systems do not attempt to track the revenue with the manner in which the customer or patient was originated.

There are also a number of dental practice management software programs available for purchase. For example, such software is available from Ace, MOGO, Dentico, from Planet DDS, Carestream Suzy Systems, Inc. (Suzydentak), Henery Schein, Inc. (Dentrix). Like the medical practice software, these programs are not configured nor are they optimized to track the manner or method of origin of the patient with the revenue that has been generated from the patient.

There are number of manners of promotion and advertisement for service industries such as the legal, medical and dental practices. However, they generally lack a system that allows the success of the lead generation to be measured in terms of revenue earned from customers, clients or patients. In connection with the dental market, some lead generations services are listed in FIG. 16. Since the market for services such as legal, dental and medical, tends to be local to the home or office of the patient or customers, marketing is performed in those manners that are directed or targeted to defined geographic regions are within a convenient drive or commute to the consumers of the services. Advertising consultants or lead generation services can identify and place advertisements in media sources such as a publications including magazines, newspapers and other media including, television, radio, direct mail, billboards.

The interne provides a further manner of communication wherein the advertisement or promotion can be communicated in response to preselected search terms or other criteria directed. Other advertising and promotion techniques include marketing using entities such Groupon®, Living Social®, other targeted email or email blast solicitation techniques. In addition, in some circumstances, phone solicitations can be an appropriate manner in which to identify individuals or leads that reside or work in particular geographic region and that may be interested in the particular goods or services offered.

Accordingly, the marketing of such locally provided services may include television, radio, displays on computers running applications, where advertisements will recommended local services provides such as dentists, lawyers and that are based upon the location of the caller, or Internet user. In addition, Internet advertisements are displayed based upon ad words to sponsored cites or directories which are based upon or triggered by the users location. Other promotional techniques include direct mail, newspapers, local directories, service provider directories, internet directories, bulletins, and such as programs and other sponsorship opportunities. It is further contemplated that the system and method of the invention could also be used in connection with direct sales calls made by sale professionals in some circumstances.

While service providers agree and understand that marketing efforts will increase the number of inquiries made to their respective organizations, it remains difficult to assess the relative efficacy of marketing expenditures using existing systems and tools. As a consequence, businesses are often reluctant to invest in promotion and advertising efforts, or will not spend the most efficient amount in advertising expenditures because the respective effectiveness is difficult to accurately measure or assess. Accordingly, some business may overly promote a campaign or not spend enough in a particular campaign to meet necessary threshold levels of market penetration.

In addition because of the lack of meaningful data regarding the relative success of a particular marketing or promotional effort, often service providers lack metrics or accurate metrics to guide them with respect to the which media expenditures are effective for their respective products or services, and how much to spend or allocate in a particular media. While it is possible to evaluate such campaigns by commissioning market studies and analysis, these techniques are often costly.

An object of the present invention is to provide an efficient and effective system and method to collect and association data relating to the origin of a particular customer or patient and associate the customer's or patient's origin to the respective revenues generated from the customer or patient over the lifetime of the service relationship.

It is further object of the invention to provide a system and method that allows the compensation of marketing and promotional professionals to be in part dependent on the relative success of the particular advertising or marketing campaign, thereby reducing upfront costs to service providers.

It is further object of the invention to provide a system and method to effectively distribute and allocate marketing and promotional expenditures to maximize effective penetration of such advertising and promotional campaigns without overspending on particular media. The present invention provides information that allows the user to control or reduce spending on marketing activities that are not effective, target spending on the most effective techniques for the particular business and to ensure marketing activities will meet threshold market penetration.

### SUMMARY OF THE INVENTION

The present invention is directed to systems and methods for collecting data relating to an initial customer contact to a businesses or other organization, tracking the costs associated with each unique advertising and promotion campaign and methods, assigning a unique identification to the customer based upon the customer origin and then, tracking the total costs attributed marketing campaigns and allocating such costs to customers and tracking the revenue earned from each customer. The information relating to the costs and revenue is then displayed to the user on a website that subscriber's can access and manipulated to provide custom reports.

In an exemplary embodiment a particular dental practice embarks on three promotional campaigns in an effort to attract new patients, an internet “ad word campaign,” television campaigns, radio campaigns and a promotional campaign placing advertisements in local publications. For example, each of the separate and distinct campaigns publishes a unique telephone number for use to make an appointment, or uses a promotional code that can be used in connection with an creating an on-line appointment. The collection of the initial contact data begins by tracking the manner in which a prospective customer makes an initial call and then an initial appointment.

Since each uses a unique identification that is associated with the promotional campaign, when the customer calls the published number, the contact event and identification can be captured in the appointment process. In the event that the initial contact originated from the internet, the system may use an optional on-line appointment process. In an exemplary on line reservation or appointment system, the prospective customer is prompted to provide information in a datafields including, 1) whether he or she is a new customer, 2) information relating to how the customer learned about the respective service provider, 3) name and contact information and 4) method of expected payment for services. If the customer self-reports as a new customer, the system will assign a unique identification number to the customer which can be subsequently used in the system to track the total revenue earned from the client relationship.

If a new patient self-reports that he learned of the organization from print sources, such as magazines, the particular campaign can be associated with the patient identification system. If the patient does not recall how the origination, a default can be in the system that is based upon the phone call used to initiate the contact. Allowing for such self-reporting allows to the system to account for circumstances where the origination may have been the result of multiple impressions upon the prospective consumer.

The system further accommodates the capture and tracking of discount codes or coupons that can be communicated in the various promotional vehicles. The origin of the discount code further verifies and corroborates the origin of the customer or patient and his or her with the advertising campaign.

To the extent that there is inconsistent information with respect to the identification of the origin of the new customers, a rule based weighted hierarchy will assign a campaign identifier to the customer, wherein the new users response to a query is weighted using the following data: self-reported identification; phone number contact identification; web-site contact data; discount or special offer code contact identifier, personal reference identifier. The system allows the user or administrator to assign weights to the respective criteria or use divide a particular customer into more than one category. Next, information is collected relating to the customer or patient including personal information, billing information. This collection step may be performed over the phone when an appointment is made, through the website portal when an appointment is made, or, when the patient arrives for services, at the service location.

In a preferred embodiment, the customer is provided a tablet computer that includes information relating to the customer that the customer can verify and elect preferences such as whether would like to receive reminder notices and manner in which the reminder should be communicated (e.g., email, text message, incoming phone call, post card, outbound phone call from call center etc.). Information collected at the service provided can then be updated and compared against information previously collected. In other embodiments, the data may be collected using a conventional questionnaire or in connection with an incoming customer or patient interview. In any event, however the information is collected, it is eventually entered into a database accessible by the software of logic that can process the data and provide the output information as further described herein.

As may be apparent to users of the system, when the respective revenue is subsequently allocated to the various origination codes that correspond to marketing and promotional efforts, the users of the system can then assess the respective efficacy of various campaigns and marketing resources can be corresponding allocated to those are most effective. Since the system is updated in real time, the promoters can invest into those particular ads that are most effective while diminishing adds that are not working with respect to generation of new contacts and leads. Further, compensation for the marketing efforts and campaigns can be directly tied to the revenue that is realized from the respective marketing campaigns, thereby providing a vested and economic incentive to the marketing firm.

As discussed above, the system further captures self-reported origination information. The self-reported information can corroborate the collected information relevant to the origin (e.g. incoming phone number, incoming web portal, discount code). Thus the customer is asked to identify how and why the customer initiated contact with the service provider. The system can accommodate situations or circumstances of new relationships that are not from targeted marketing campaigns but rather contact is initiated as a result of personal relationships with service providers, personal referrals, professional referrals, customer referrals or merely former customers that may have had previous relationship with the service provider but are no longer considered an active account.

Thus, the present system captures customer and or patient origination data and then associates the origin in both predefined categories as well as user defined categories. This information can be subsequently used by service provider to reward the referring customers or professional referrals.

Next, the customer origination information is then linked or associated with the service providers existing billing and accounting software. In commercial embodiments, the system is provided with or is integrated with proprietary billing and accounting software. In an embodiment of the invention, the system captures predefined data fields from an excel data and includes the origination data, revenue and costs data relating to or associated with the particular origination data. In embodiments of the invention, the customer or patient origination data profile is with restricted or limited access so the integrity of the will be maintained. Such security measures are particularly important or desirable if the revenue distribution and compensation is dependent on the output of the system.

### BRIEF DESCRIPTION OF THE DRAWINGS

FIG. 1 is a screen shot of an output screen according to an embodiment of the invention is depicted.

FIG. 2 is a schematic illustration of the architecture used in connection with the invention.

FIG. 3 is a schematic illustration of the pay per lead flow of information and data according to embodiments of the invention.

FIG. 4 is a schematic illustration of voice recording hosting configuration that is used in embodiments of the invention.

FIG. 5 is a schematic illustration of an embodiment of the system including a billing platform.

FIG. 6 is a schematic representation of the informational flow of the pay per lead system.

FIG. 7 is a screen shot of a web based search result on Google and, includes a listing of paid advertisements.

FIG. 8 is a screen shot of en exemplary web page that identifies a dentist in response to an Internet search for dentist based upon the users zip codes.

FIG. 9 is a schematic illustration of the steps employed by call center steps of for a prospective patient that calls a phone number to a lead generation entity.

FIG. 10 is an exemplary record generated by a lead generator service that is transmitted to a subscriber of the lead generation service.

FIG. 11 is a screen shot of a calendar used to schedule a patient in conventional practice management software.

FIG. 12 is a dashboard display of the present invention depicting different data than that was illustrated in FIG. 1 that includes the respective procedures scheduled for the patents and the patent number.

FIG. 13 is a schematic representation of a computer system on which the method of the invention may be implemented.

FIG. 14 is a schematic representation of network diagram on which the invention may be implemented.

FIG. 15 is a flow chart that depicts the flow of information as it captured from a phone call according to embodiments of the system.

FIG. 16 is a flow chart that depicts the flow of information in the system as it is stored and processed in the database.

FIG. 17 is a flow chart depicting the flow of information as it originates from a lead website.

### DETAILED DESCRIPTION OF THE INVENTION

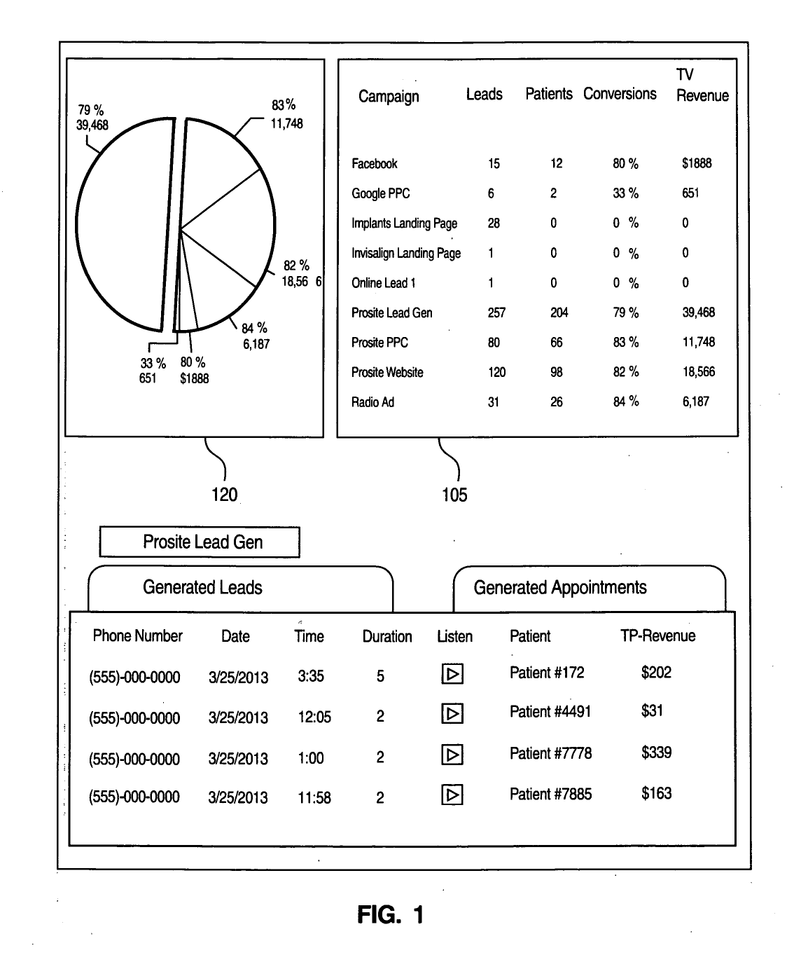

Now referring to FIG. 1, a screen display is depicted that illustrates data that has been collected and processed in connection with a series of marketing campaigns for a dental practice. The screen shot includes integrated data that tracks the performance of a plurality of marketing campaigns including web based systems 101, such as facebook, Google and various product driven webpages such as Implants and Invisiline and a data 103 from a Prosite lead generation firm that that includes radio advertisements, the lead generation website and Prosite Pay per click (“PPC”) advertising and promotional efforts. The leads are tracked by incoming phone numbers in section that includes data from the Prosite lead generation system. Field 105 includes the total number of leads generated 108 from the various promotional efforts, the number of patients that are identified or captured 110 from the number of leads 108, a conversion rate 112 calculated from the number of leads and number of patients, and the total patient revenue 115. The relative marketing performance is illustrated in field 120. As illustrated therein, the Prosite lead generation system is depicted as the most effective marketing system generating revenues of 39, 468 over the period measured. This is followed by the Prosite Website lead generation system having a higher conversion rate of 82% and revenues of $18,556.00. At the bottom of the screen, a field 150 is displayed that allows for each lead generated from the various source to be accessed and analyzed. As depicted, each of the leads from the Prosite lead generation campaign are displayed and each patients phone number, the date of contact. The duration of the call is provided. In addition, the system maintains an audio file of the phone call that allows the users to assess the nature of the call and thereby further refined the market message. Each of leads that results in an appointment is also broken down by total revenue for the respective patient 152. Here the patient is provided with a unique identifier 160 that is correlated with the origin of the patient contact.

In embodiments, the system further reminders for periodic follow-up visits for further dental work such as cleanings and check-ups, etc. These reminders can be implemented by the self-directed including emails, text, direct mailings and phone calls. The phone calls may be automated calls or can provide a list of those patients that are due for services and the calls can be made by a call center or by the service provider. The can direct the customer to the website, if that or track the new appointment in the system when the phone call is made.

In a further step of the invention, when a new patient or customer enters the system, conventionally, a patient completes a form including such information as the patient's name, addresses, relevant numbers, guarantor, employer, summary of relevant medical history, allergies, and the like. Once all or part of a patient's demographics is recorded, or in conjunction therewith, the patient is scheduled for an appointment. In preferred embodiments, this data intake and recording step is completed at the both the time of the appointment using an on line questionnaire and is later confirmed by the office of the service provider. The decision to schedule a patient or customer for an appointment involves determining: the type of services requested, the availability of services provides to provide the requested services, other office resources availability and, the urgency of the services needed. After an appointment is scheduled, the customer or patient's relevant records are retrieved prior to the patient's appointment.

If more than one user is simultaneously accessing the site, the first patient to select the time will be provided access to the time slot and the time will be as unavailable to subsequent users. The time slot will be confirmed as an appointment and any patent that attempts to submits the same time will be notified that the therein is a conflict with the selected time and be requested to selected a new time for the services.

At the time of the appointment, the customer is welcomed by office staff and is provided with material to sign in. The sign-in step signals to the office staff that the patient or customer as arrived, and the patient or customer is provided with sheet or tablet computer to confirm information relating to customer, profile information, the patient's or customer's request for services and method of expected payment. Next the tablet or sign in sheet is returned to office administration staff that can check to confirm that the required elements have been completed.

Next the customer or patient is seen by a service provider. When the service is completed the service provider makes a record or report of the services provided, that can be performed by data entry or by dictation. In preferred embodiments, the system of the invention is configured to receive audio transcription files for subsequent processing. The report also triggers the system to receive follow-up appointments as well as billing program, to create and an invoice for the services provided. A report is generated, and associated with the customer or patient's records.

Following the appointment or after a service is provided, the customer is billed at the time of servicer or, in some circumstances, through a third party payer. Completed services may be selected from a menu of pre-selected services and pre-established billing codes or amounts for standard the services. Other charges are credits are applied to the account. Payment is made by the patient or customer and/or through a through a third party payer, When a third party payer receives an invoice, the invoice is paid according to the rules and policies who may pay according to their pre-established fee schedules and other terms. Each service provider must verify payment accuracy and other account issues.

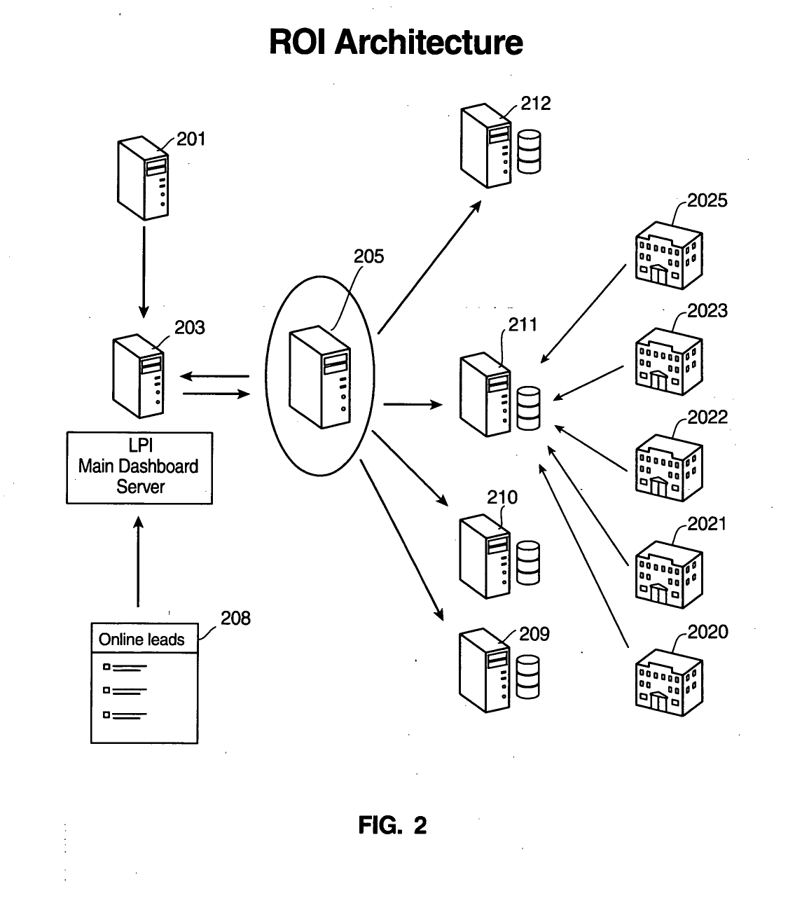

Now referring to FIG. 2 the architecture of an embodiment of the system is schematically illustrated. The system includes a customer data record phone lead component 201 that captures new patient leads. Next data from leads are copied and captured and then matched with AM referenced server 205. Leads are also captured from online leads from a website or number of websites 208. These leads are then processed in the main dashboard server 203 and can be compared with the referenced server 205. The system reference server receives data from a plurality of production servers 209-1022 that each receives data from customer which may comprise dental practice office 2020-2025. Each customer can access the corresponding ROI server using their respective production server.

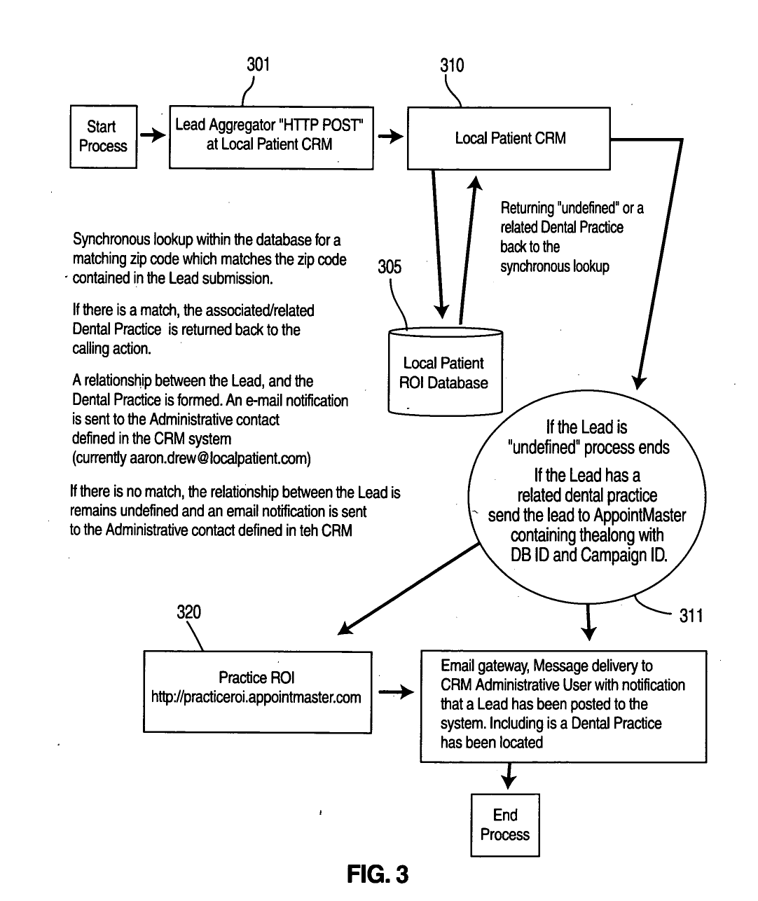

Now referring to FIG. 3 a data flow schematic is illustrated that relates to a pay per lead model. Here the system captures relevant leads from phone call and internet sites or other such as text messages and aggregated the leads in at step 301 and creates customer management records 301. These records are then saved into the server database 305 and can be accessed as system records 310. If a lead is not adequately defined the process ends at step 311. If the lead can be associated with a customer using predefined rules, the lead transferred at step 325 wherein an email or other message is transmitted to a dental practice or customer administrator. In addition, a step 315 the lead may be developed into an appointment using appointment process software at step 320 and appointment data is transmitted to the practice administrator.

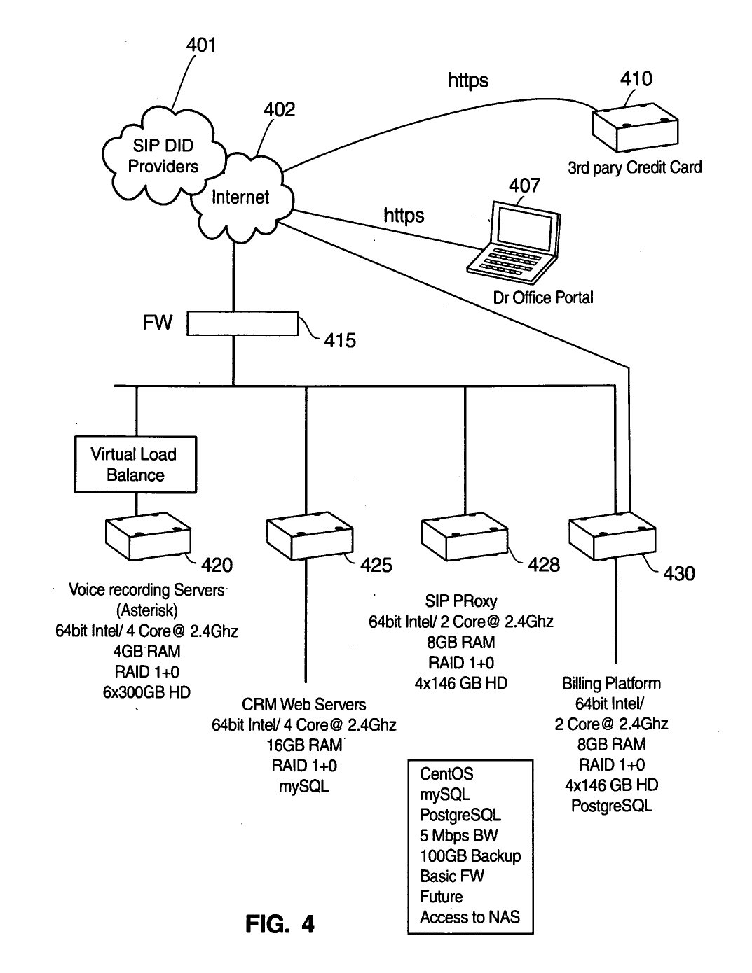

Now referring to FIG. 4, the customer record management system that includes the voice recording of incoming calls to create customer record is schematically illustrated. The hardware required includes SIP DID providers 401 that transmit data over the internet as was as information from the Customer portal 407 and third party credit card processors 410. Information from the internet is received in server 415 and routed to a voice recording server 420, a CRM server 425, a SIP proxy server 428 or the billing platform 430.

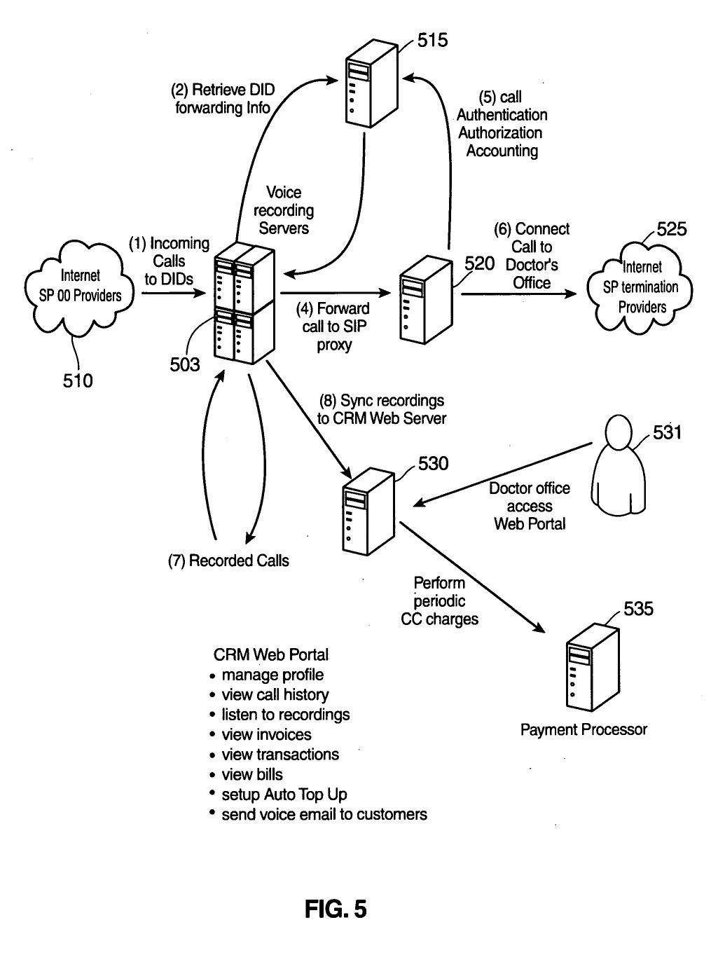

FIG. 5 depicts the voice recording CRM billing platform and system used in an embodiment of the invention that includes voice recording servers 503, the billing platform 515, and SIP proxy switch 520. Calls or messages from the internet 510 are routed to voice recording servers 503. This data is then transferred to the CRM (customer record management) web server 530 that provides the customer 531. The payment processor 535 communicates with the server 530.

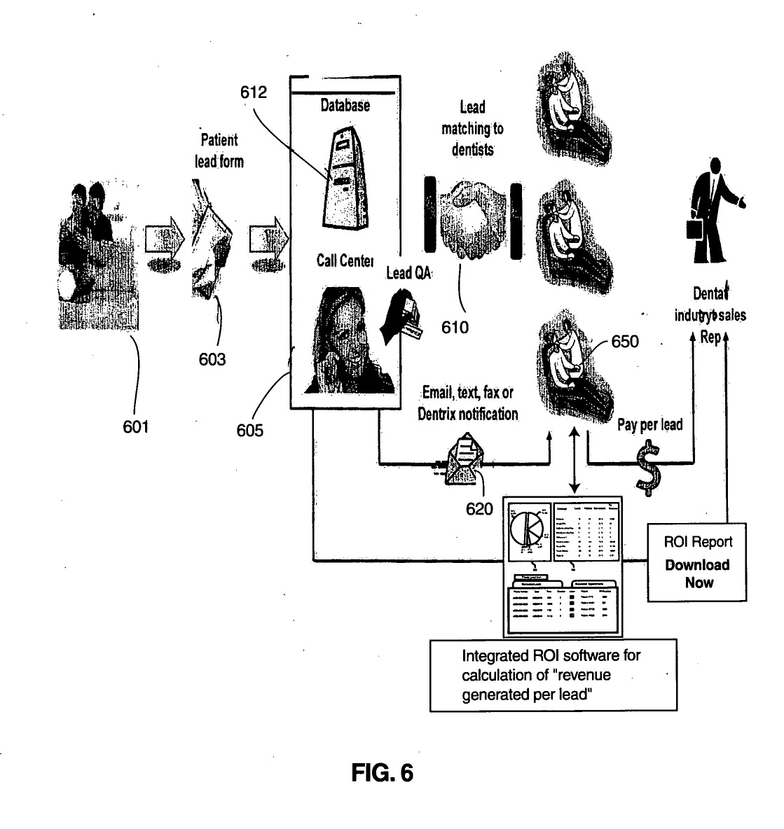

Now referring to FIG. 6, according to the lead program offered by the system and method a prospective customer 601 in search of goods or services locates the lead generation from advertising or through search functions. The customer or patient fills out a lead form 603 which may result in a call from the call center 605. At call center 605, the prospective customer is then matched with participating service using the call center database 612 provides such as dentists 610 or other service provided d. Alternatively, a prospective customer may directly contact the call center. Call cent then contacts by email 620 a user or subscriber 630 which will then pay for the lead. In addition, the database provides a ROI service 650 which includes a dashboard that allows the user or subscriber to track the revenue that is generated by each lead.

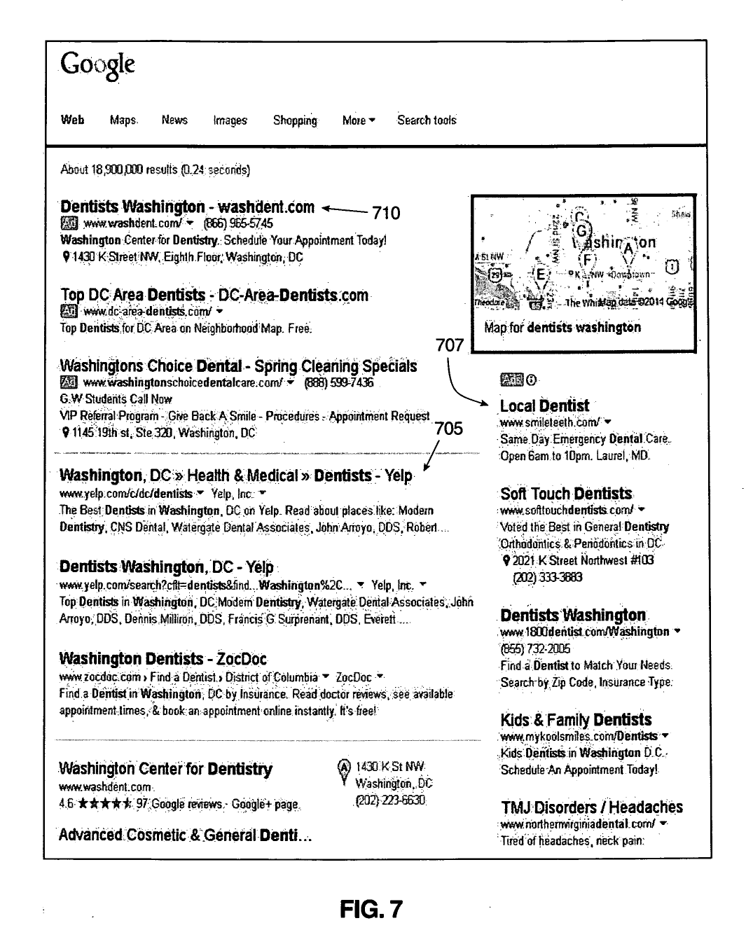

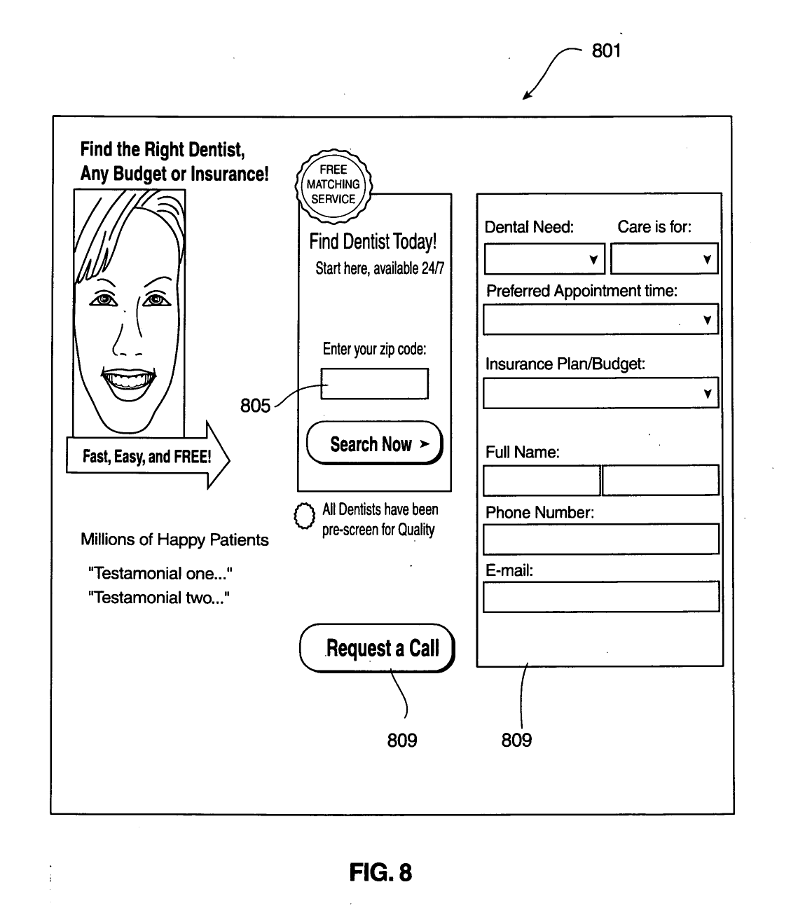

FIG. 7 depict a web page reflecting the search results from an internet search engine for the term “Dentist DC.” The results include paid advertisements displayed on the right hand side 707 as well as paid ad words. The top field also displays that have paid the search engine for prominent placement. According to the method of the invention, in retune for a subscription to leads, the operator may place one or more advertisements or purchase ad words that will direct the prospective patients or customer to relevant landing pages. An exemplary landing page 801 is depicted in FIG. 8 which directs a prospective customer to enter a zip code in data entry field 805 as well as other information that is relevant to the services that they seek in region 809. The prospective customer may also request that the service provider call them by access link 809.

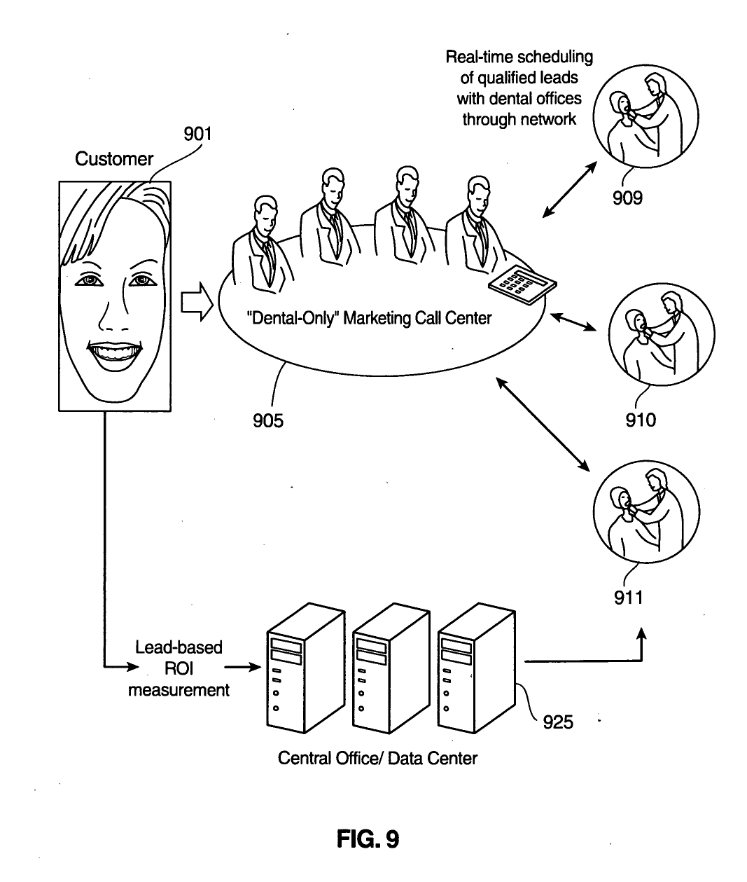

Now referring to FIG. 9 in response to a call or contact from a prospective customer 901, the call center 905 will then arrange for an appointment for services to be provided by user-subscribers 909-911 of the system. Alternatively, the call center may forward the calls directly to the user subscriber depending on the framework selected. At the same time it the call center will provide a unique contact ID to the caller and collect data relating to the customer in a data center 925 that will also be correlated with the fees paid over the life of the customer-user relationship that is collected from the service provider. This system allows an automated measurement of the return on investment or ROI for each prospective lead that has been generated by the system and method of the invention. This information, that includes customer origination data, revenue earned from each customer and revenue paid per lead, is then displayed to the user-subscriber on a dashboard such as that depicted in FIG. 1 and the user-subscriber can access the dashboard.

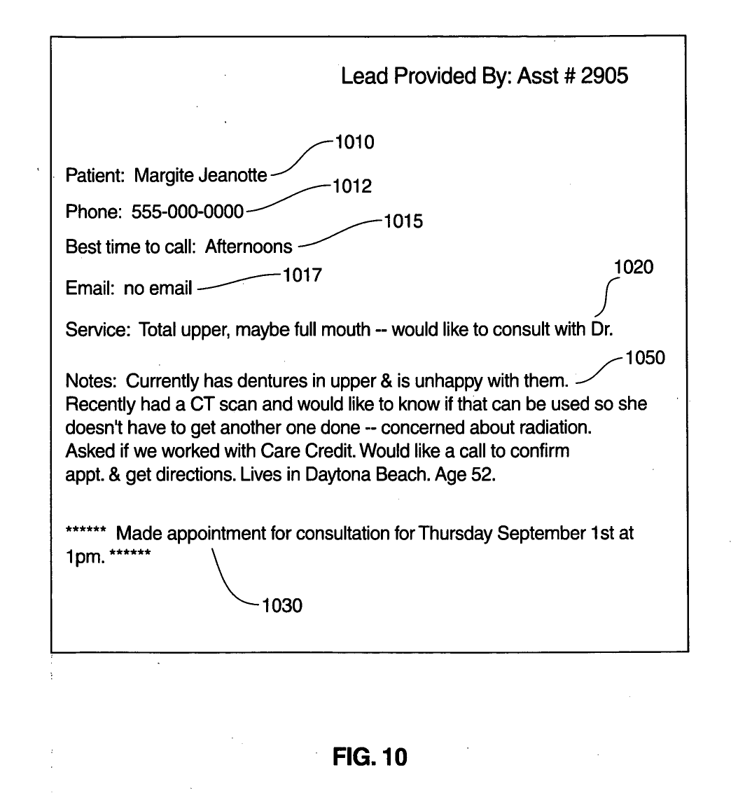

FIG. 10 depicts exemplary lead information that is captured by the system and provided to the respective user subscriber. The information depicted includes the name 1010, phone number or numbers 1012, preferred contact time 1015, email 1017; service sought 1020 and other relevant information 1050. If an appointment was made, the appointment time is also communicated at 1030.

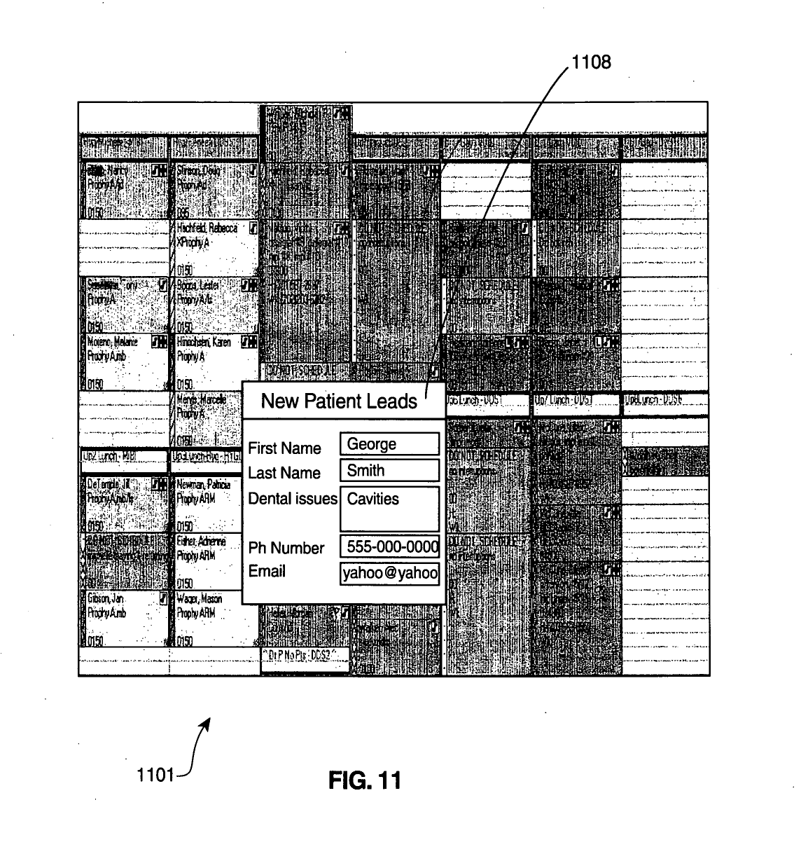

FIG. 11 reflects a conventional patient scheduling software interface 1101 that can accessed by the data call center to book a particular time. In addition to the memorializing the time in the calendar, in embodiments, the system will also generate an email notification that a new appointment has been made. The email may notify the user-subscriber as well as the customer. The new information is displayed in 1108 when the system is opened by the user subscriber.

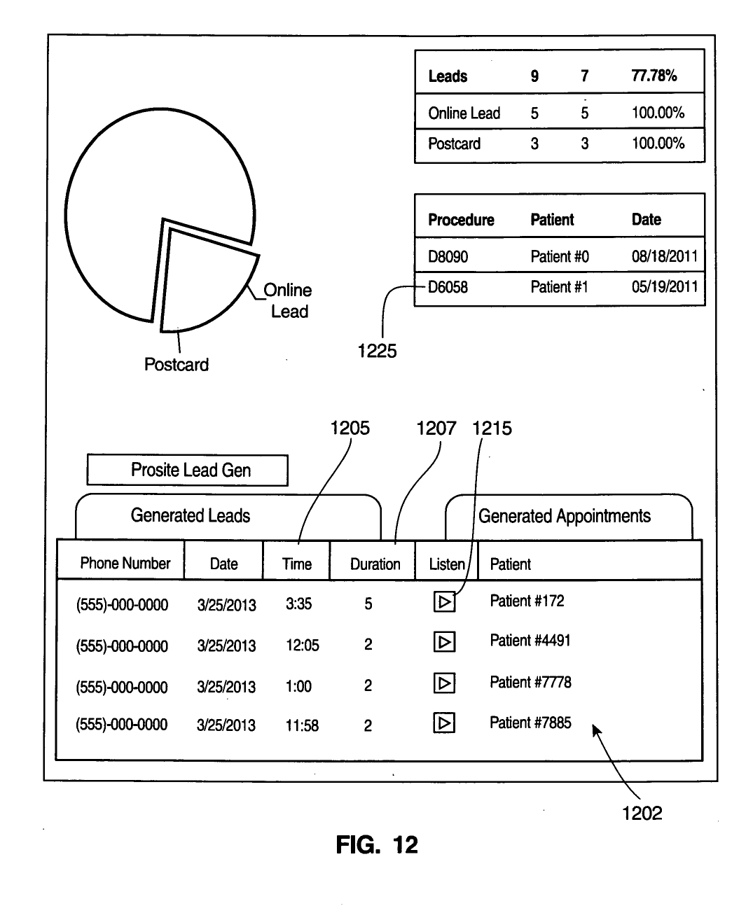

FIG. 12 is a dashboard display 1202 that illustrates some of the data display functions that can be accessed by the system. In addition to the leads by a particular internet, radio or television campaign, the system can track postcard leads as well. The display also can display the time of particular phone contact and duration of the call at filed 1205 and 1207. If the service provided would like to listen to a particular call, it can accessed by activating link 1215. The data can also display the particular services that are routinely requested in field 1225 wherein the can cater the advertising message to either popular or economically more favorable services.

Features of the system are provided to ensure that the data that is captured, stored and displayed is reliable. For example, the following feature will reduce to a minimum the number of duplicates records in the system. Patient leads may be issued by three entry points: by phone, form, and manual. Wherein manual refers to the loading of existing customer patient data. Since it is an object to keep track of all leads in the database for possible future use, a new column “ORIGINAL” is defined for each lead, indicating if the lead is actually a lead that should be matched, displayed and counted in the dashboard. Leads with a designation or flag “non original” will not be displayed in the dashboard and will not be counted in the ROI. In order to implement a database, the following rules are applied: (1) An original lead is a Valid Lead(*) that has pop-up in the system when no other Similar Leads(**) have been found; (2) Valid Lead must be at least 30 sec long, if coming from phone origination system; (3) Similar Lead Two lead are considered similar when they share at least one Valid Differentiator. These Valid Differentiator's are (1) a valid phone, (2) a valid Name and First Name; and (3) A valid email (expect list to be provided like np@np.com)

Next, a second process is run periodically to identify invalid leads as Original to handle the less than 30 second leads that may have been incorrectly converted to patient leads and there are no other original leads for that patient. The modules of the system that are affected by this process include the phone originated CDRs (customer data record) reading: screening of all leads incoming from Phone originated leads to apply the rule defined, the Form entry CDRs: screening of all leads incoming from the form to apply the rule defined, the Dashboard (filter counted and displayed lead to only display Original Lead) and for cleaning the existing database. A new module “cleans” e.g. removes duplicate and incomplete data from the existing leads database as described below. To remove duplicate and incomplete patient records the system executes a program that read all leads, account by account, sorted by time stamp, from the earlier to the latest and apply the rule defined above. Next all leads are removed if they do not meet the 18 month criteria. In other embodiments this time can be adjusted. If there is information reflecting a duplicate lead the system can either automatically remove or the system and prompt an administrator to review and confirm the record is a duplicate. The resulting deleted records are stored in a deleted lead table.

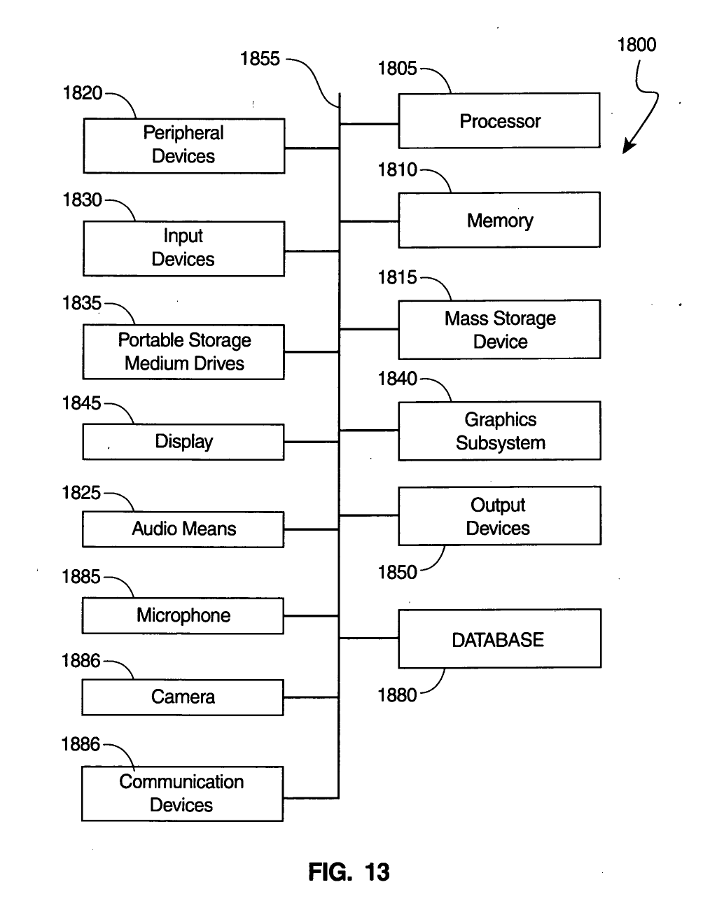

FIG. 13 is a block diagram of a data processing apparatus 1800 that can be incorporated as part of both the system and method of the invention. The data processing apparatus 1800 includes a processor 1805 for executing program instructions stored in a memory 1810. The memory 1810 stores instructions and data for execution by processor 1905, including instructions and data for performing the methods described above. The data includes the various reference standards. Depending upon the extent of software implementation in data processing apparatus 1800, the memory 1810 stores executable code when in operation. The memory 1810 includes, for example, banks of read-only memory (ROM), dynamic random access memory (DRAM), as well as high-speed cache memory.

Referring to FIG. 13, within data processing apparatus 1800, an operating system comprises program instruction sequences that provide a platforn1 for the methods described above. The operating system provides a software platform upon which application programs may execute, in a manner readily understood by those skilled in the art. The data processing apparatus 1700 further comprises one or more applications having program instruction sequences according to functional input for performing the methods described above.

The data processing apparatus 1800 incorporates any combination of additional devices. These include, but are not limited to, a mass storage device 1815, one or more peripheral devices 1820, a loudspeaker or audio means 1825, one or more input devices 1830 which may comprise a touchscreen, mouse or keyboard, one or more portable storage medium drives 1835, a graphics subsystem 1840, a display 1845, and one or more output devices 1850. The input devices in the present invention include a camera and microphone. The various components are connected via an appropriate bus 1855 as known by those skilled in the art. In alternative embodiments, the components are connected through other communications media known in the art. In one example, processor 1805 and memory 1810 are connected via a local microprocessor bus; while mass storage device 1815, peripheral devices 1820, portable storage medium drives 1835, and graphics subsystem 1840 are connected via one or more input/output buses.

In embodiments, computer instructions for performing methods in accordance with exemplary embodiments of the invention also are stored in processor 1805 or mass storage device 1815. The computer instructions are programmed in a suitable language such as C++.

In embodiments, the portable storage medium drive 1835 operates in conjunction with a portable non-volatile storage medium, such as a floppy disk, CD-ROM, or other computer-readable medium, to input and output data and code to and from the data processing apparatus 1800. In some embodiments, methods performed in accordance with exemplary embodiments of the invention are implemented using computer instructions that are stored on such a portable medium or are downloaded to said processor from a wireless link. Peripheral devices 1820 include any type of computer support device, such as a network interface card for interfacing the data processing apparatus 1800 to a network or a modem.

Still referring to FIG. 13, the he graphics subsystem 1840 and the display 1845 provide output alternatives of the system. The graphics subsystem 1840 and display 1845 include conventional circuitry for operating upon and outputting data to be displayed, where such circuitry preferably includes a graphics processor, a frame buffer, and display driving circuitry. The display 1845 may include a cathode ray tube display, a liquid crystal display (LCD), a light emitting diode display (LED) or other suitable devices. The graphics subsystem 1840 receives textual and graphical information and processes the information for output to the display 1845

In embodiments, instructions for performing methods in accordance with exemplary embodiments of the invention are embodied as computer program products. These generally include a storage mediun1 having instructions stored thereon used to program a computer to perform the methods disclosed above. Examples of suitable storage medium or media include any type of disk including floppy disks, optical disks, DVDs, CD ROMs, magnetic or optical cards, hard disk, nash card, smart card, and other media known in the art.

Stored on one or more of the computer readable media, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable media further include software for performing the methods described above.

In certain other embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN). Those skilled in the art will recognize that merely transferring the program over the network, rather than executing the program on a computer system or other device, does not avoid the scope of the invention. For instance, the Database may not be in proximity to the processor and the processor may communicate remotely with the database. In other contemplated embodiments, other data relating to a particular customer may be located, downloaded and displayed and from the internet.

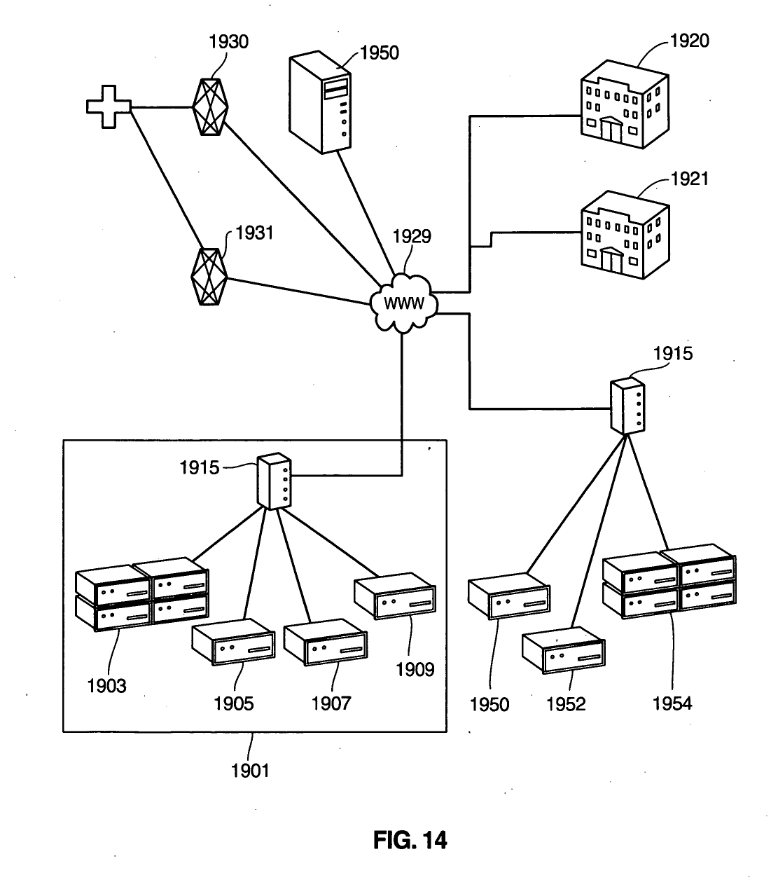

Now referring to FIG. 14, in embodiments the invention is implemented on a distributed network that includes a host system 1901 that included a voice recording server 1903, a customer relationship management web server 1905, a SIP (Session Initiation Protocol) proxy server 1907 and billing platform server 1909. This back end system is protected from the web by firewall 1915. The system further includes multiple doctors' offices 1920 and 1921 that have computer systems that can access the system through the work wide web 1925. The system also includes a credit card proceeding facility 1930 that may be outsourced and call origination and termination service providers 1930 and 1931 that provide data relating to calls that have been converted to Voice over IP systems. The system also includes server 1950 that can be accessed to provide the ROI dashboard to subscribers. The server is connected to the ROI database server 1952 that access data that may be stored in a database (not shown) that has been captured and stored relating to the a particular patient or customer and an application server 1954 that allows subscribers to create custom reports.

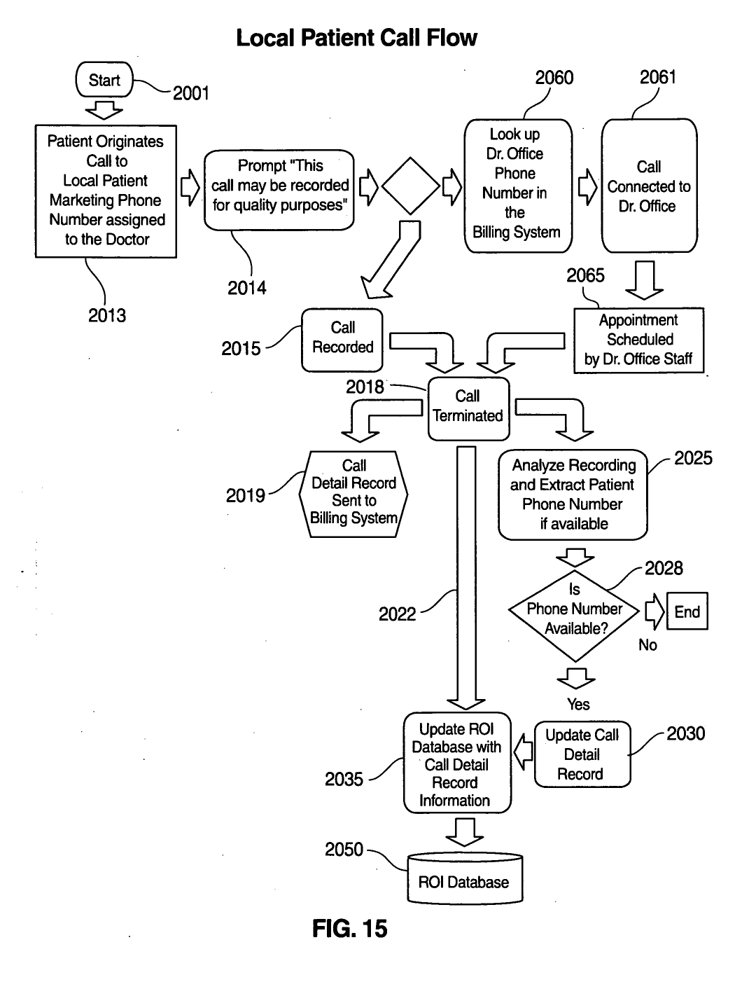

Now referring to FIG. 15, the flow of information from a new customer call is through the system. After the start step 2001 information relating to the origin of the phone call is capture and assigned to a particular customer at step 2013. Next, at step 2014 the customer is advised that the phone call may be recorded which may be required by law and can include useful data. At step 2015 the call is recorded. When the call is terminated at step 2018 the call detail may be sent to the billing system at step 2019. The data may also be sent to the update the ROI database at step 2035 with details relating to the call including the identification of the patient, insurance information, contact information and particular customer preferences. The data base is depicted at 2050. Other data processing including extracting the patient phone number at step 2025 and if available the call record detail is updated at step 2030. The audio file is supplemented with data that is gleaned from the call including self reported information as well as data that is associated with the call itself such as the time and information relating to its origin. The incoming number is also compared to existing numbers in the users bulling system at step 2060. If the call is from an existing patient, the call may be forwarded directly to the user at step 2061 and an appointment may be scheduled at step 2065.

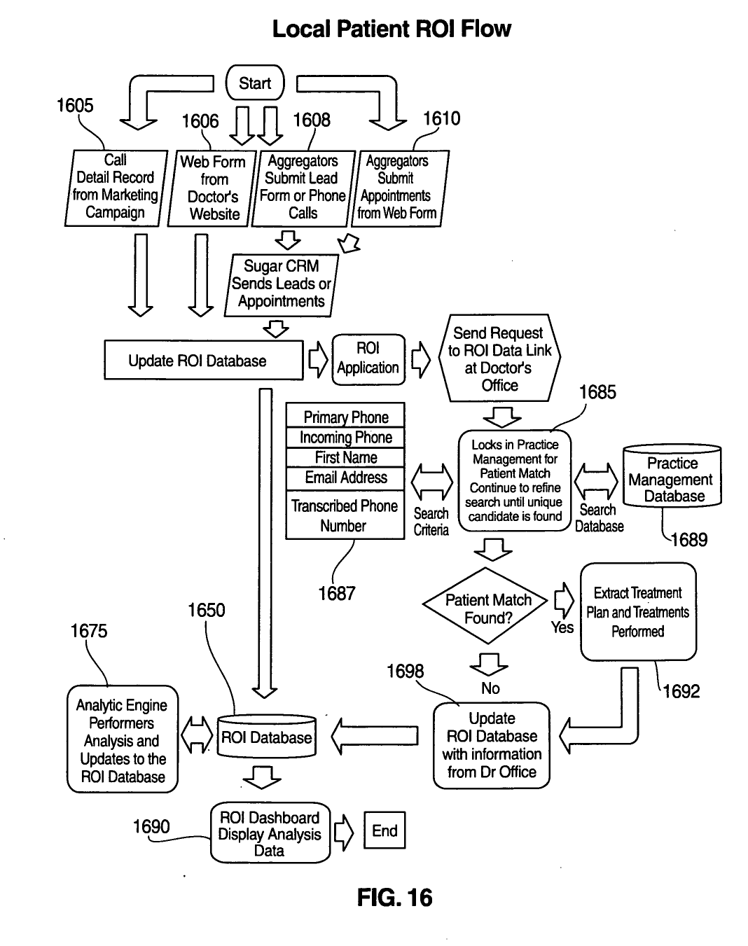

FIG. 16 illustrates a series of steps wherein business of patient leads are generated from a plurality of sources that include phone calls 1605, web based forms, 1606k, aggregators that submit lead forms of phone calls or 1608 and aggregators that submit appointments 1610. Aggregators may include commercial lead generation firms such as 1-880-Dentist, firms that conduct lead generation activity from the internet or firms using other marketing techniques. Leads are sent to a database administrated by the system owner which tracks the origin of the respective leads and correlates the leads with prospective customers. This correlation may include the consideration of geographic location, customer preference, the nature of service provided, other designated preference, and the ability of the service provider to meet the needs of the prospective customer. This step may be automated by matching relevant zip codes and other data entry fields or may be manually administrated. The information from the leads is processed into relevant data fields and stored in a database 1650. The data in database 1650 may be periodically processed in step 1675 to provide output and to ensure that the data is reliable. In response to an output request, data from said database may be displayed in dashboards 1690. The data may also be output in printed form (not shown). FIG. 16 also shows the steps wherein the new data is matched to a user subscriber database 1685. In this process, the information from new leads 1687 is also compared to data in a serve provider existing customer data base 1689 to ensure that a lead is not erroneously created. If a lead is matched with a service provide and the lead is a new patient or customer, a record is sent to database 1650 to update the new lead with user subscriber data. As revenue is generated by the user subscriber 1992, the revenue is reported to the database 1650 according to the respective to the patient identifier at step 1698. Period auditing may be performed to endure that the user-subscriber complies that and that revenue from leads are appropriately calculated.

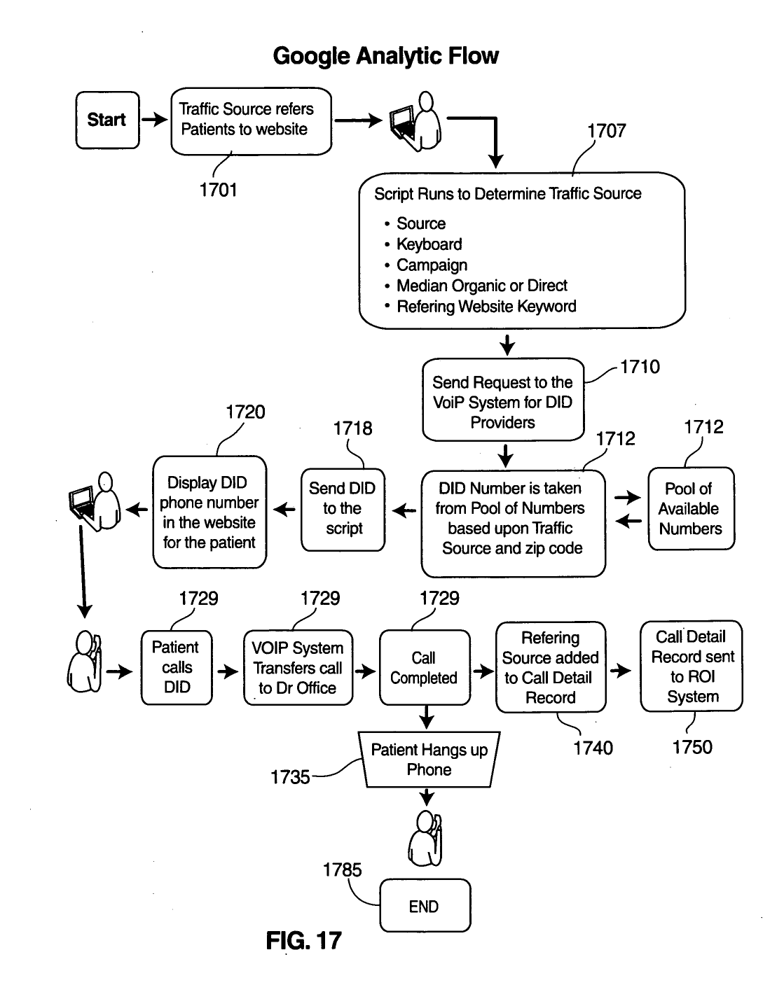

Now referring to FIG. 17, a search engine data analytic flow is depicted according to embodiments of the invention at step 1701. In this embodiment, traffic is directed to a particular landing page website using conventional marketing techniques, internet search optimization or other techniques. Next an application script runs to determine the source of the traffic, which may be keyword, a referring website, a campaign, or other source at step at step 1707. Next a request for a VOIP system is initiated and a DID number is assigned to the based upon the traffic source and zip code. This data is captured in the lead generation profile. Next the DID is sent to a further application that will run and locate an appropriate phone number to display to the customer at the website at step 1720. Alternatively, the patient can access the designated or assigned user subscriber based upon a web based form. Then customer or patient is then prompted to call the DID and over the phone or VOIP system at step 1720 which will transfer the call to a designed location at step 1730. When the call is made, the call is recorded and information is captured relating to the prospective lead. When the call has been completed the referring source is added to the call detail record at step 1740. At step 1750 the call detail record is sent to the database of the ROI system.

The present invention has been illustrated and described with respect to specific embodiments thereof, which embodiments are merely illustrative of the principles of the invention and are not intended to be exclusive or otherwise limiting embodiments. Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with the claims that follow.

I claim:

1. A customer or patient management system comprising at least one electronic device having:
a display; a memory; and a processor operating in accordance with software for receiving an identifier associated with a customer said identifier associated with a predefined marketing campaign with each customer identifier, calculating the data indicative of payment history of said customer, calculating data relating to advertising and promotion expenditures for each customer that originates from each predefined marketing campaign and correlating said expenditure data relating to said advertising and promotion with each customer or patient and customer or patient origin, and displaying said cost and revenue for each said customer on a display.

2. The customer or patient management system of claim 1, wherein said marketing campaign includes web base pay per click marketing systems.

3. The customer or patient management system of claim 1, wherein the cost of the marketing campaign is tracked and associated with the respective revenue earned.

4. The customer or patient management system of claim 1 wherein said marketing campaign includes radio advertisements.

5. The patient and practice management system of claim 1, wherein said marketing campaign includes television advertisements.

6. The patient and practice management system of claim 5, wherein said marketing campaign includes print media based advertisements.

7. The patient and practice management system of claim 1, wherein the identifier is an identifier of a patient identification number and the software is configured to track revenue of the customer over the life of the customer relationship or to a predetermined endpoint.

8. The patient and practice management system of claim 1, wherein an output is generated that reflects the total billed services provided for the patient, less the costs associated with the marketing campaign.

9. The patient and practice management system of claim 8, wherein an output compares the profitability of a plurality of the lead generation systems.

10. The patient and practice management system of claim 1, wherein the software is configured to generate an indication of whether the lead generation system is profitable.

11. The patient and practice management system of claim 1, wherein the software is configured to generate a report that shows the lifetime costs allocated to the patient, revenue from the patient, billings, and the manner in which the patient was captured.
